(19) United States
(12) Patent Application Publication
(10) Pub. No.: US 2005/0120384 A1
(43) Pub. Date: Jun. 2, 2005

(54) Methods and systems for enabling software and firmware downloads to high definition television appliances

(75) Inventors: Christopher J. Stone, Newtown, PA (US); Chris Del Sordo, Souderton, PA (US)

Correspondence Address: Lipsitz & McAllister, LLC, 755 MAIN STREET, MONROE, CT, 06468, US

(73) Assignee: General Instrument Corporation, Horsham, PA (US)

(21) Appl. No.: 10/725,283

(22) Filed: Dec. 1, 2003

(51) Int. Cl. H04N 7/173; G06F 9/445; G06F 9/44; H04N 7/16; G06F 13/00; H04N 5/445

(52) U.S. Cl. 725/132; 725/140; 725/152; 725/50; 717/168; 717/172; 717/174; 717/178

(57) ABSTRACT

The present invention enables software and firmware downloads to high definition television (HDTV) appliances via a television terminal. A download control message received at the terminal may comprise: (i) a first version identifier identifying a version of an available software or firmware download; (ii) a first type identifier identifying a particular type of HDTV appliance for which the download is intended; and (iii) a download object containing the software or firmware to be downloaded. The terminal obtains a second type identifier from the HDTV appliance that identifies a type of the HDTV appliance. If the type identifiers correspond, the terminal obtains a second version identifier from the HDTV appliance, which identifies a current version of software or firmware of the HDTV appliance. If the version identifiers do not correspond, the terminal may pass the download object to the HDTV appliance.

### BACKGROUND OF THE INVENTION

The present invention relates generally to the field of digital video interfaces. In particular, the present invention provides methods and systems for enabling software and firmware downloads to high definition television (HDTV) appliances over digital video interfaces, such as a Digital Visual Interface (DVI) and/or a High Definition Multimedia Interface (HDMI).

HDTVs currently do not have a way in which to obtain software and/or firmware upgrades when connected to a source device, such as a television terminal. In the case where the HDTV is connected to an antenna and/or coax cable and receives off-air and cable TV signals, a means may exists to provide software and/or firmware downloads. However, when the HDTV is connected to a source device via a DVI and/or HDMI link, the ability to receive off-air and/or cable TV signals is removed. The HDTV connected to a television terminal only receives raw video data. Therefore, the ability to download software and firmware via off-air and/or cable is removed. Typically, upgrades of software or firmware for HDTVs connected to a television terminal are performed on-site, for example, by changing FLASH memory cards in the HDTV.

Since DVI and HDMI protocols are so new and are subject to change before HDTVs are shipped, it would be advantageous to provide a mechanism to download new software and firmware to an HDTV from a remote location via a television terminal.

The methods and systems of the present invention provide the foregoing and other advantages.

### SUMMARY OF THE INVENTION

The present invention provides methods and systems for enabling software and firmware downloads to high definition television appliances. In an example embodiment of the invention, a download control message is forwarded to a television terminal associated with a high definition television appliance from a download source. The download control message may comprise: (i) a first version identifier which identifies a version of an available software or firmware download; (ii) a first type identifier which identifies a particular type of high definition television appliance for which the download is intended; and (iii) a download object containing the software or firmware to be downloaded. The terminal is capable of obtaining a second type identifier from a high definition television appliance associated with the terminal that identifies the type of the high definition television appliance. The first and second type identifiers are compared at the terminal. If the first and second identifiers correspond, the television terminal is enabled to obtain a second version identifier from the high definition television appliance. The second version identifier identifies a current version of software or firmware of the high definition television appliance. The terminal then compares the first version identifier to the second version identifier. If the first version identifier does not correspond to the second version identifier, the terminal may pass the download object to the high definition television appliance.

Corresponding methods and systems are provided in accordance with the present invention.

### BRIEF DESCRIPTION OF THE DRAWINGS

The present invention will hereinafter be described in conjunction with the appended drawing figures, wherein like reference numerals denote like elements, and:

FIG. 1 shows a block diagram of an example embodiment of the invention;

FIG. 2 shows an example embodiment of a download control message in accordance with an example embodiment of the invention; and

FIG. 3 shows a block diagram of an example embodiment of a television terminal and a high definition television appliance in accordance with an embodiment of the invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an example embodiment of the invention. It should be understood that various changes may be made in the function and arrangement of elements without departing from the spirit and scope of the invention as set forth in the appended claims.

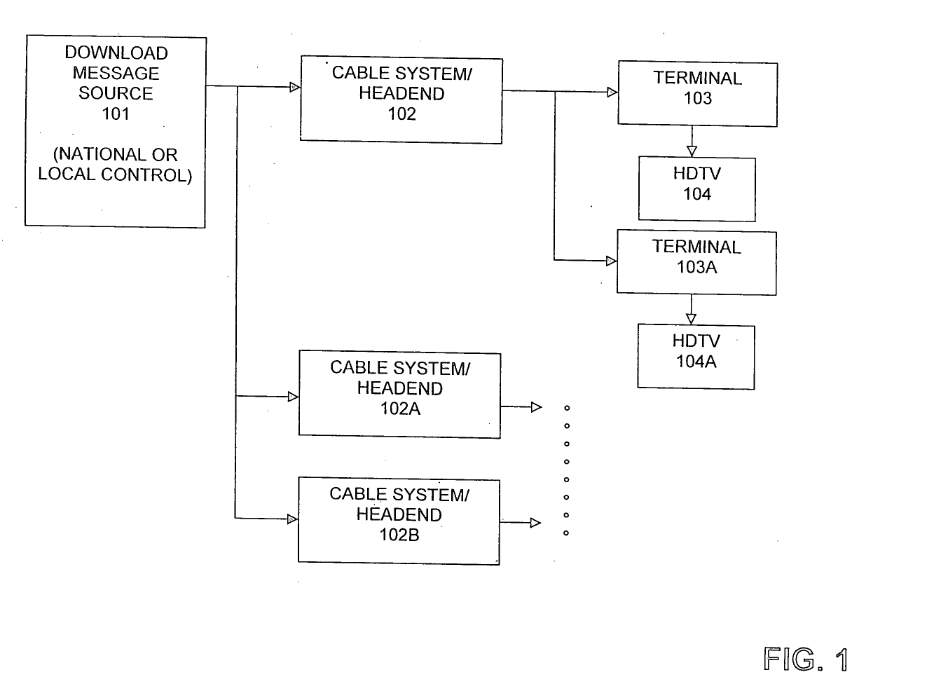

The present invention provides methods and systems for enabling software and firmware downloads to high definition television appliances. In an example embodiment of the invention as shown in FIG. 1, a download control message is forwarded from a download source 101 to a television terminal 103 associated with a high definition television appliance 104. Those skilled in the art will appreciate that the present invention is applicable to a television distribution network for delivering download control messages to a plurality of television terminals (e.g., terminals 103, 103A, and 103B, etc.) from a download source 101 via a number of national or local headends (e.g., headends 102, 102A, 102B). FIG. 1 represents a simplified version of such a distribution network, which may include several headends 102 each serving thousands of terminals 103.

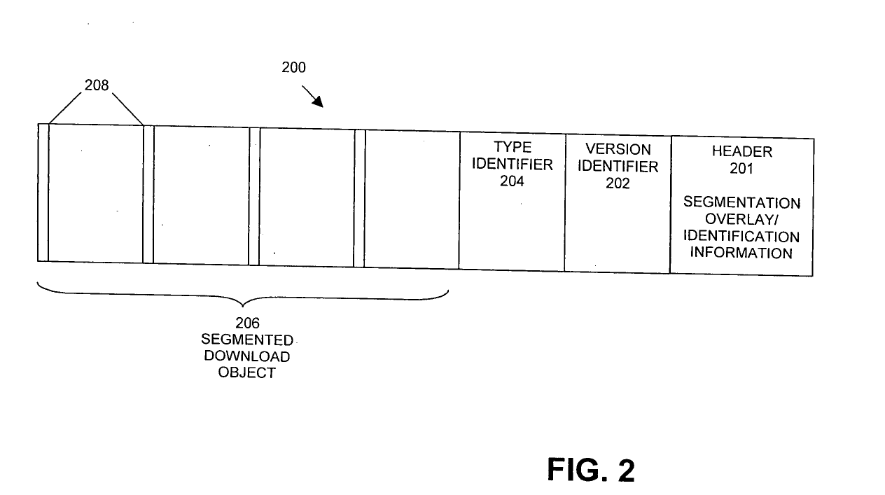

The download control message, which may be sent from a download source 101 via a control channel to the television terminal 103, provides a way of identifying which code object is to be loaded into the HDTV appliance 104. As shown in FIG. 2, the download control message 200 may comprise: (i) a first version identifier 202 which identifies a version of an available software or firmware download; (ii) a first type identifier 204 which identifies a particular type of high definition television appliance for which the download is intended; and (iii) a download object 206 containing the software or firmware to be downloaded. The terminal 103 is capable of obtaining a second type identifier from a high definition television appliance 104 associated with the terminal 103 that identifies the type of the high definition television appliance 104. The first and second type identifiers are compared at the terminal 103. If the first and second identifiers correspond, the television terminal 103 is enabled to obtain a second version identifier from the high definition television appliance 104. The second version identifier identifies a current version of software or firmware of the high definition television appliance 104. The terminal 103 then compares the first version identifier 202 to the second version identifier. If the first version identifier 202 does not correspond to the second version identifier, the terminal 103 may pass the download object to the high definition television appliance 104.

The first version identifier 202 may identify an updated version of software or firmware as compared to the current version of software or firmware. In the event that the first version identifier 202 identifies an older version of software or firmware as compared to the current version of software of firmware running on the high definition television appliance 104, the download object 206 may not be passed to the high definition television appliance 104. However, those skilled in the art will appreciate that there may be instances when it is desirable to provide an older version of software or firmware to the high definition television appliance 104, for example when an updated software version is being recalled.

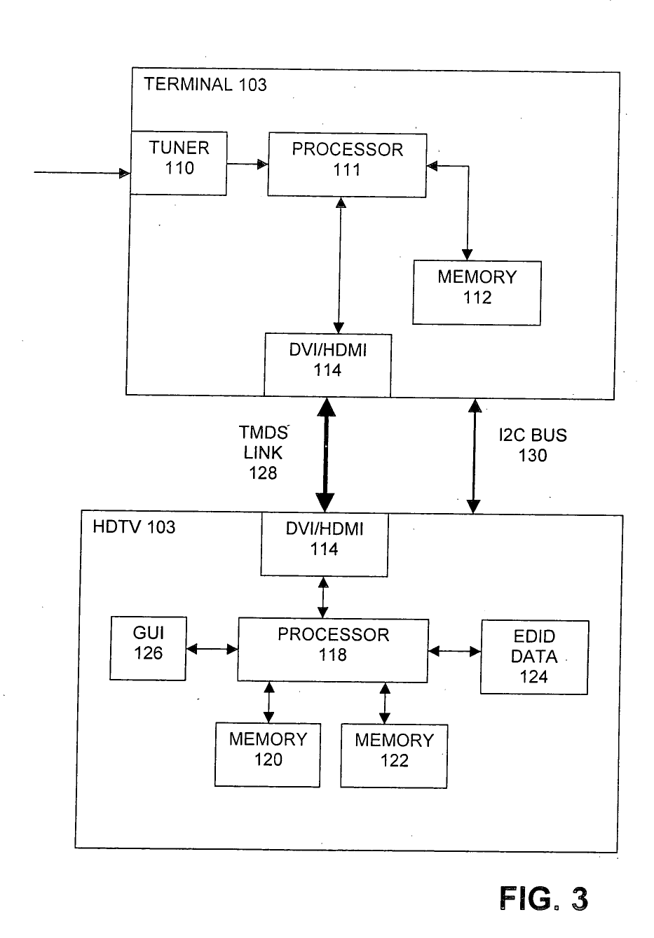

As shown in FIG. 3, the download object 206 may be passed from the television terminal 103 to the high definition television appliance 104 via an interface 114, which may be either a digital visual interface or a high definition multimedia interface.

In a further example embodiment of the invention, an authorization check may be provided prior to passing the download object 206 to the high definition television appliance 104. In addition, authentication between a download source 101 and the television terminal 103 may also be provided. For example, an object signature message may be provided that is associated with the download object 206 via an object identifier. First, an authorization check is made before the downloading of the download object 206 begins, if this fails then the download is aborted, if it passes then the download can proceed. The next step is an authentication process between the head-end controller 102 and the terminal 103. The download object 206 may be loaded into volatile memory of the terminal 103 so that a signature-based authentication can be performed. If this authentication fails the download is aborted; if this authentication passes then the download will proceed.

The download control message 200 may comprise a segmented message as shown in FIG. 2. Since the terminal 103 will not permanently store the download object 206 in non-volatile memory, there must be a way to send segments of the download object 206 to the HDTV appliance 104. The download control message 200 may include a segmentation overlay in the header 201 of the message and unique identification information that ties each segment to the particular download object 206 being loaded.

Each segment of the download control message 200 may have a cyclic redundancy check (CRC) trailer 208, this trailer can be used by the HDTV appliance to check that it has received a piece of the download object 206. This mechanism will allow secure transmission of the HDTV appliance's download object 206 piece by piece.

The terminal 103 may initially determine whether the associated high definition television appliance 104 supports downloads of software or firmware. The terminal 103 may then report to the download source 101 whether the high definition television appliance 104 supports downloads.

Arrangements may also be made with individual HDTV manufactures that will allow the terminal 103 to pass the download control message 200 directly to the HDTV appliance 104 and let the HDTV appliance 104 process the download object 206 the same way as the terminal 103 does, without any processing at the terminal 103.

In a further example embodiment of the invention as shown in FIG. 3, the current version of software or firmware may be stored in a first storage location (e.g., memory 120) at the high definition television appliance 104. The download software or firmware may be stored in a second storage location (e.g., memory 122). Those skilled in the art will appreciate that the two storage locations may comprise separate memory as shown in FIG. 3, or separate segments of the same memory. For example, the two storage locations may constitute two separate blocks within FLASH, two separate FLASH chips, or the like, in with which to simultaneously store the current firmware/software that is running on the HDTV appliance 104 and the new firmware/software that is being downloaded. This enables the robustness of the downloaded software or firmware to be verified without affecting the current software or firmware. If the robustness of the downloaded software or firmware is verified, the high definition television appliance 104 may be rebooted and the downloaded software or firmware may be loaded from the second storage location 122 and executed at processor 118. If the downloaded software or firmware is not operable, the high definition television appliance 104 may revert to the software or firmware in the first storage location 120. In essence, the HDTV appliance 104 will ping-pong back and forth between the two storage locations after each successful download.

The status of the download may be reported back to the download source 101 from the terminal 103. The download source 101 may use this knowledge to remove the firmware/software from the download mechanism after all downloads have completed.

A graphical user interface 126 may be generated on the high definition television appliance 104 to inform a user that the download is available. The user interface 126 may also inform the user whether the download is available to for a fee or free of charge. If the user agrees to the fee or agrees to accept the download, then the terminal 103 will commence the download process. If the user declines, then the terminal 103 will not update the firmware/software of the HDTV appliance 104.

Each HDTV appliance 104 may contain Extended Display Identification Data (EDID) 124 which may include a Monitor Descriptor Block as defined by the Video Electronics Standards Association (VESA). The monitor descriptor block of the EDID data 124 at the high definition television appliance 104 may be modified to enable the download of software or firmware in accordance with the present invention. An example of a modified monitor descriptor block in accordance with the invention is shown in Table 1 below.

TABLE 1
Modified Monitor Descriptor Block

| NUMBER OF | | | |
|---|---|---|---|
| BYTES | BYTE | DESCRIPTOR | VALUE / DESCRIPTION |
| 18 | 2 | Flag | Flag = 0F0Fh, to indicate download information block |
| | 1 | Flag | Reserved = 00h |
| | 8 * | Software/Firmware | First 6 most significant bytes indicate major version number. Last 2 least |
| | | Version identifier | significant bytes indicate minor version number (e.g. 145.6) in decimal |
| | | | equivalence. |
| | 1 * | Flag | 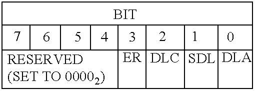 |
| | | | DLA = Download Available, set by source device to indicate that a download is |
| | | | available for the connected device. Cleared by the connected device when the |
| | | | download starts. |
| | | | SDL = Start Download, set by the connected device to inform the source device |
| | | | that it is ready to accept a download. The source device will clear this bit when |
| | | | the download starts. |
| | | | DLC = Download complete, set by the source device when all of the download |
| | | | packets have been transmitted to the connected device. The connected device |
| | | | clears the bit after it has reassembled the download image. |
| | | | ER = Error Indication, if set then read the bits in the following byte. |
| | 1 * | Error | 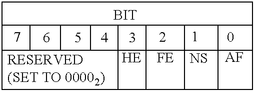 |
| | | | AF = Authentication failed, download again. Set by the receiving device (i.e. |
| | | | the HDTV) if the robustness check of the image is not successful. Cleared by |
| | | | the sending device (i.e. the terminal) when a new download is attempted or on a |
| | | | timeout |
| | | | NS = Not enough space for download object error indication. Set by the |
| | | | connected device if the size of the object to be downloaded and/or is in the |
| | | | process of being downloaded exceeds the physical storage space of the device. |
| | | | Cleared by the sending device to acknowledge the error. The sending device |
| | | | may decide to initiate the download a second time. |
| | | | FE = FLASH Error, Set by the connected device if the FLASH memory of the |
| | | | device is corrupted and/or has some problem with writing the code objects. |
| | | | Cleared by the sending device to acknowledge the error. The sending device |
| | | | may decide to initiate the download a second time. |
| | | | HE = Hardware Error. Set by the connected device if some type of hardware |
| | | | errors occurs that prevents the completion of the download of the code objects. |
| | | | Cleared by the sending device to acknowledge the error. The sending device |
| | | | may decide to initiate the download a second time |
| | 5 | Reserved | All bits set to zero |

In Table 1, the modified portions of the monitor descriptor block are designated by an asterisk. The monitor descriptor block may be modified to include the second version identifier. For example, in the modified monitor descriptor block shown in Table 1, 8 bytes are allocated to the software/firmware version identifier (i.e., the second version identifier). The first 6 most significant bytes of the software/firmware version identifier indicate major version number and the last 2 least significant bytes indicate minor version number (e.g. software version 145.6) in decimal equivalence.

The monitor descriptor block may be further modified to include indicators for at least one of download available (DLA), start download (SDL), download complete (DLC), and download error (ER) as shown in Table 1. The download error may be one of authentication failed (AF), insufficient space for download (NS), flash error (FE), or hardware error (HE) as shown in Table 1. Those skilled in the art will appreciate that further modifications may be made to the monitor descriptor block in accordance with the invention, and that those modifications illustrated in Table 1 are exemplary only.

There will be many different types of HDTV appliances in existence, and each type will need a unique download object. Since each HDTV manufacturer supplies a manufacturer or type identification in the EDID data 124, the television terminal 103 would compare this information to a similar type identifier 204 in the download control message 200. If the type identifiers do not match, then the terminal 103 would discard the message since it is not for this particular HDTV appliance. If they match, then the terminal 103 would compare the software version identifier 202 in the download control message 200 to the software version identifier from the modified monitor descriptor block shown in table 1.

In an example embodiment of the invention, the television terminal 103 may communicate with the HDTV appliance 104 via an I2C bus 128 and read the HDTV appliance's EDID data 124. If the HDTV appliance 104 supports software/firmware downloads, then the EDID data 124 may be constructed to indicate such (i.e. the EDID data 124 will contain the modified Monitor Descriptor Block as defined in Table 1). The terminal 103 may determine that a download is supported and obtain information about the current software/firmware version installed on the HDTV appliance 104. The terminal 104 may then receive software/firmware from the download source 101 via the cable headend 102 that is applicable to the HDTV appliance 104. The terminal 103 may then write to a well-known location within the HDTV appliance's EDID data 124 to indicate that software/firmware is available (i.e. sets DLA). The HDTV appliance 104 indicates that it is ready for a download via setting a well-known EDID register (i.e. sets SDL). The television terminal 103 may clear a well-known EDID value to indicate that the download is going to commence (i.e. clears SDL). The terminal 103 then interrupts the video signal on the TMDS link 128 between the DVI or HDMI interface 116 and transmits the download object 206 via the TMDS link 128. The format of the download packets would be such that they contain information required to reassemble the entire download image and check for robustness as discussed above (e.g., a CRC check trailer). The download may also take place over the I2C bus 130. However, the I2C bus 130 is much slower than the TMDS link 128 and as such would require a longer time to complete a large download. The terminal 103 sets a well-known EDID value when all of the download packets have been transmitted to the HDTV appliance 104 (i.e. sets DLC). The HDTV appliance 104 may perform a robustness check on the image (e.g., performing a CRC check) and if all is well, then it clears the EDID value (i.e. clears DLC). If the robustness check is not successful, then the HDTV appliance 104 will indicate that an error has occurred and the download process will start over again. The number of attempts at a download may be set by the HDTV appliance manufacture.

It should now be appreciated that the present invention provides advantageous methods and systems for enabling software and firmware downloads to high definition television (HDTV) appliances over digital video interfaces, such as a Digital Visual Interface (DVI) and/or a High Definition Multimedia Interface (HDMI).

Although the invention has been described in connection with various illustrated embodiments, numerous modifications and adaptations may be made thereto without departing from the spirit and scope of the invention as set forth in the claims.

1. A method for enabling software and firmware downloads to high definition television appliances, comprising:
forwarding a download control message to a television terminal associated with a high definition television appliance, said download control message comprising: (i) a first version identifier which identifies a version of an available software or firmware download; (ii) a first type identifier which identifies a particular type of high definition television appliance for which said download is intended; and (iii) a download object containing said software or firmware to be downloaded;
enabling said terminal to obtain a second type identifier from said high definition television appliance that identifies the type of said high definition television appliance;
comparing said first and second type identifiers;
if said first and second identifiers correspond, enabling said television terminal to obtain a second version identifier from said high definition television appliance identifying a current version of software or firmware of said high definition television appliance;
comparing said first version identifier to said second version identifier; and
if said first version identifier does not correspond to said second version identifier, passing the download object from said television terminal to said high definition television appliance.

2. A method in accordance with claim 1, wherein:
said first version identifier identifies an updated version of software or firmware as compared to said current version of software or firmware.

3. A method in accordance with claim 1, wherein:
in the event that said first version identifier identifies an older version of software or firmware as compared to said current version of software of firmware, said download object is not passed to said high definition television appliance.

4. A method in accordance with claim 1, wherein:
the download object is passed from the television terminal to said high definition television appliance via one of a digital visual interface or a high definition multimedia interface.

5. A method in accordance with claim 1, further comprising:
providing an authorization check prior to passing said download object to said high definition television appliance.

6. A method in accordance with claim 1, further comprising:
providing for authentication between a download source and the television terminal.

7. A method in accordance with claim 1, wherein:
said download control message comprises a segmented message.

8. A method in accordance with claim 7, wherein said download control message further comprises a cyclic redundancy check (CRC) trailer to enable verification that each segment of said download is received.

9. A method in accordance with claim 1, further comprising:
determining by said terminal whether said associated high definition television appliance supports downloads of software or firmware; and
reporting from the terminal to a download source whether said high definition television appliance supports downloads.

10. A method in accordance with claim 1, further comprising:
enabling the download control message to pass directly to the high definition television appliance from the download source via the television terminal without processing by said television terminal.

11. A method in accordance with claim 1, wherein:
said current version of software or firmware is stored in a first storage location; and
said download software or firmware is stored in a second storage location.

12. A method in accordance with claim 11, further comprising:
verifying the robustness of the downloaded software or firmware;
if said robustness is verified, rebooting said high definition television appliance and loading the downloaded software or firmware from said second storage location; and
if said downloaded software or firmware is not operable, reverting to said software or firmware in said first storage location.

13. A method in accordance with claim 1, further comprising:
reporting a status of the download back to the download source.

14. A method in accordance with claim 1, further comprising:
generating a graphical user interface on said high definition television appliance to inform a user that said download is available; and
enabling a user to accept or refuse said download.

15. A method in accordance with claim 14, wherein said download is provided for a fee.

16. A method in accordance with claim 1, further comprising:
modifying a monitor descriptor block of Extended Display Identification Data (EDID) at said high definition television appliance to include said second version identifier.

17. A method in accordance with claim 16, further comprising:
further modifying said monitor descriptor block to include indicators for at least one of download available, start download, download complete, download error, authentication failed, insufficient space for download, flash error, and hardware error.

18. A system for enabling software and firmware downloads to high definition television appliances, comprising:
a download source for creating and transmitting a download control message, said download control message comprising: (i) a first version identifier which identifies a version of an available software or firmware download; (ii) a first type identifier which identifies a particular type of high definition television appliance for which said download is intended;
and (iii) a download object containing said software or firmware to be downloaded;
a television terminal for receiving said download control message; and
a high definition television appliance associated with said television terminal; wherein:
said terminal obtains a second type identifier from said high definition television appliance that identifies the type of said high definition television appliance;
said terminal compares said first and second type identifiers;
if said first and second identifiers correspond, said television terminal obtains a second version identifier from said high definition television appliance which identifies a current version of software or firmware of said high definition television appliance;
said terminal compares said first version identifier to said second version identifier; and
if said first version identifier does not correspond to said second version identifier, the download object is passed from said television terminal to said high definition television appliance.

19. A system in accordance with claim 18, wherein:
said first version identifier identifies an updated version of software or firmware as compared to said current version of software or firmware.

20. A system in accordance with claim 18, wherein:
in the event that said first version identifier identifies an older version of software or firmware as compared to said current version of software of firmware, said download object is not passed to said high definition television appliance.

21. A system in accordance with claim 18, further comprising:
one of a digital visual interface or a high definition multimedia interface between the television terminal and said high definition television appliance.

22. A system in accordance with claim 18, wherein:
said terminal provides an authorization check prior to passing said download object to said high definition television appliance.

23. A system in accordance with claim 18, wherein:
said terminal provides for authentication between a download source and the television terminal.

24. A system in accordance with claim 18, wherein:
said download control message comprises a segmented message.

25. A system in accordance with claim 24, wherein said download control message further comprises a cyclic redundancy check (CRC) trailer to enable verification that each segment of said download is received.

26. A system in accordance with claim 18, wherein:
said terminal determines whether said associated high definition television appliance supports downloads of software or firmware; and
said terminal reports back to the download source whether said high definition television appliance supports downloads.

27. A system in accordance with claim 18, wherein:
the download control message is enabled to pass directly to the high definition television appliance from the download source via the television terminal without processing by said television terminal.

28. A system in accordance with claim 18, further comprising:
a first storage location for storing said current version of software or firmware; and
a second storage location for storing said download software or firmware.

29. A system in accordance with claim 28, wherein:
said high definition television verifies the robustness of the downloaded software or firmware;
if said robustness is verified, said high definition television appliance reboots and loads the downloaded software or firmware from said second storage location; and
if said downloaded software or firmware is not operable, said high definition television appliance reverts to said software or firmware in said first storage location.

30. A system in accordance with claim 18, wherein:
said terminal reports a status of the download back to the download source.

31. A system in accordance with claim 18, wherein:
a graphical user interface is provided on said high definition television appliance to inform a user that said download is available; and
a user is enabled to accept or refuse said download via said user interface.

32. A system in accordance with claim 31, wherein said download is provided for a fee.

33. A system in accordance with claim 18, wherein a monitor descriptor block of Extended Display Identification Data (EDID) is modified at said high definition television appliance to include said second version identifier.

34. A system in accordance with claim 33, wherein:
said monitor descriptor block is further modified to include indicators for at least one of download available, start download, download complete, download error, authentication failed, insufficient space for download, flash error, and hardware error.

35. A high definition television appliance adapted for receiving software or firmware downloads, comprising:
one of a digital visual interface or a high definition multimedia interface for enabling communication with a television terminal;
a first memory location containing Extended Display Identification Data (EDID) having a monitor descriptor block modified to include a first version identifier identifying a current version of software or firmware running on said high definition television appliance;
a second memory location containing said current version of software or firmware; and
a processor for executing said current version of software or firmware;
wherein:
said terminal is adapted to receive a download control message from a download source, said download control message comprising: (i) a first version identifier which identifies a version of an available software or firmware download; (ii) a first type identifier which identifies a particular type of high definition television appliance for which said download is intended; and (iii) a download object containing said software or firmware to be downloaded;
said terminal is adapted to obtain a second type identifier from said high definition television appliance that identifies the type of said high definition television appliance;
said terminal is adapted to compare said first and second type identifiers;
if said first and second identifiers correspond, said television terminal is adapted to obtain a second version identifier from said high definition television appliance which identifies said current version of software or firmware of said high definition television appliance;
said terminal is adapted to compare said first version identifier to said second version identifier; and
if said first version identifier does not correspond to said second version identifier, said terminal is adapted to pass the download object to said high definition television appliance via one of said digital visual interface or said high definition multimedia interface.

36. A high definition television appliance in accordance with claim 35, wherein:
said monitor descriptor block is further modified to include indicators for at least one of download available, start download, download complete, download error, authentication failed, insufficient space for download, flash error, and hardware error.

37. A high definition television appliance in accordance with claim 35, wherein:
said first version identifier identifies an updated version of software or firmware as compared to said current version of software or firmware.

38. A high definition television appliance in accordance with claim 35, wherein:
in the event that said first version identifier identifies an older version of software or firmware as compared to said current version of software of firmware, said download object is not passed to said high definition television appliance.
